(19) United States
(12) Patent Application Publication
(10) Pub. No.: US 2014/0282245 A1
(43) Pub. Date: Sep. 18, 2014

(54) DYNAMIC ICONS

(71) Applicant: LOCKERTECK PTY LTD, Bondi Junction (AU)

(72) Inventor: Andrew Scarborough, North Bondi (AU)

(73) Assignee: LOCKERTECK PTY LTD, Bondi Junction (AU)

(21) Appl. No.: 13/841,218

(22) Filed: Mar. 15, 2013

(30) Foreign Application Priority Data
Mar. 15, 2013 (AU) 2013900911

(51) Int. Cl. G06F 3/0484; G06F 3/0481

(52) U.S. Cl. CPC G06F 3/04842; G06F 3/04817
USPC 715/811

(57) ABSTRACT

A portable electronic device that includes a memory for storing a plurality of applications and information relating to a plurality of icons, a display for displaying at least one of the icons, a user interface for allowing the user to select the at least one icon displayed on the display, and a processor for determining which of the plurality of icons to be displayed on the display according to a predetermined criterion, among other things.

### CROSS-REFERENCE TO RELATED APPLICATIONS

This application claims priority to Australian Provisional Application No. 2013900911 filed Mar. 15, 2013, the disclosure of which is incorporated herein be reference.

### TECHNICAL FIELD

The present invention relates to portable electronic devices and in particular to systems and methods for displaying advertisements on portable electronic devices and will be described with reference to this application. However, it will be appreciated that the invention is not limited to this particular field of use.

### BACKGROUND ART

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Portable electronic devices have increased in popularity and many people now carry at least one portable electronic device with them throughout the day. The device may take the form of a portable computer, a mobile phone, a smart phone, a personal digital assistant, personal music player or the like. User difficulties in accessing and transporting multiple devices has led to the introduction of newer smart devices that can run multiple applications on a single device thereby avoiding the need for a user to carry multiple devices around with them. Instead the user simply activates the desired application (app) function on the smart device and can switch to another application as required. Many devices also provide the user with the ability to download and install new applications onto the smart device.

Typically, smartphone devices and tablets include a display or a list of icons that allows the smartphone or tablet user to launch the various applications installed on a smartphone or tablet device.

In light of the above, there is great demand for new applications, however, there is reluctance from some users to pay for each application they wish to use. In lieu of payment, or in some instances even in conjunction with payment, users are happy to receive advertising on their smartphone or tablet device.

### SUMMARY OF THE INVENTION

Smart phone devices have become very popular in recent years. With this popularity, the industry for developing software applications (known as “apps”) for smart phone devices has grown. This industry has also extended to tablet computers, on which apps can also be run. There are many developers that develop apps to suit an extremely wide range of differing interests amongst smart phone device and tablet users. These include, for example, apps for games or other forms of entertainment, apps for business purposes, apps for education and information sharing, and so on. Such apps have been identified as an effective medium for generating advertising.

Indeed, it is very common for the goods or services of one provider to be advertised by apps developed by another party. Such adverts typically appear in visual form on the screens of smart phone devices, while users are interacting with the devices.

It will be appreciated that, in order for an advert of a particular provider to be presented by the use or running of an app on a smart phone device, the app must be suitably configured to cause that advert to appear. Usually, an intermediate party is involved in taking the steps necessary for the provider's advert to be triggered by the developer's app. There are numerous competing businesses that act as such intermediaries, often referred to as advertising (or ad) networks. Typically, such businesses will have information about providers wishing to advertise on apps developed by developers, and also information relating to such developers. As a result, such advertising networks are often well-placed to introduce providers that wish to advertise, to app developers wishing to incorporate the adverts of providers within their apps.

Part of the service typically provided by advertising networks includes the developing and providing of software which is suitable to be installed in the apps of developers, in order to incorporate the adverts of providers.

Such software may be of a largely standardised nature, and may require relatively little input by the providers, or by the ad network itself, in order to incorporate the provider's adverts, and relatively little adaptation by the app developers (of that software or their apps).

Typically, the apps together with the incorporated software are configured to be presented on the smart phone devices or tablet computers, and for users to interact with the adverts, for example by actuating hyperlinks incorporated in the adverts when they are presented, or by entering information into onscreen forms presented by the adverts, and so on.

Typically, the relationship between the providers, ad networks, and app developers is such that, when some predetermined form of interaction occurs between a user of a smartphone device or tablet computer and an advert (for example when the user actuates a hyperlink), a record will be retained of the event, and will trigger a remuneration payment for the ad network and to the developer, which will be paid by the advertising provider. Indeed, this is typically the primary source of revenue for many developers

For this reason, many apps are made available for download by smart phone device or tablet computer users for free, or for a nominal fee.

There are various different forms of adverts that may be used in such apps. However, the approach to making the adverts as effective as possible in relation to their ability to draw smart phone or tablet computer users to engage with the adverts, and to purchase the goods or services to which the adverts relate, has been somewhat hit and miss. As a result, there is potential for improvement in the effectiveness of adverts, based on the manner in which they are used.

The preferred embodiment of the present invention overcomes or ameliorates at least one of the disadvantages of the prior art, or at least provides a useful alternative.

According to a first aspect of the invention there is provided a portable electronic device including:

a memory for storing a plurality of applications and information relating to a plurality of icons;

a display for displaying at least one of icons;

a user interface for allowing the user to select the at least one icon displayed on the display; and

a processor for determining which of the plurality of icons to be displayed on the display according to a predetermined criterion

Preferably the processor further determines the prescribed manner in which the icons are displayed.

Preferably at least one of the respective icons actuates a respective secondary application when selected by the user. Preferably the secondary applications include app marketplace applications and/or web browsers. Preferably the secondary applications include advertisements.

In some embodiments at least one of the respective icons actuates a uniform resource locator (URL). Preferably the URL links include advertisements.

Preferably the electronic device includes a network interface for connecting the device to a network. Preferably the network is the Internet. In some embodiments the connection is through a mobile phone network, WIFI, Bluetooth, Ethernet.

Preferably the electronic device communicates with an information server via the Internet for updating the information relating to the plurality of icons on the portable electronic device.

Preferably the criterion for determining which of the plurality of icons to be displayed or updated on the display of the device includes at least one of: time (including time of day, month or year); user information (such as user age, sex, interests); historical user selection of the icon; other icons present on the device; statistics based on the device or application usage; usage analysis/profile; user profile.

Preferably the prescribed manner in which the plurality of icons are displayed on the display of the device includes at least one of: time (including time of day, month or year); user information (such as user age, sex, interests); historical user selection of the icon; other icons present on the device; statistics based on the device or application usage.

According to a second aspect of the invention there is provided a telecommunications system including the portable electronic device described above.

Throughout the specification and claims which follow, unless the context requires otherwise, the word “comprise”, and other variations such as “comprises” and “comprising”, will be understood to imply the inclusion of a stated integer or step or group of integers or steps but not the exclusion of any other integer or step or group of integers of steps.

### BRIEF DESCRIPTION OF THE DRAWINGS

A preferred embodiment of the invention will now be described, by way of example only, with reference to the accompanying drawings in which:

FIG. 1 is a screen of a smart phone of according to the invention;

FIG. 2 is conceptual diagram of a system according to the invention.

### PREFERRED EMBODIMENT OF THE INVENTION

The preferred embodiment of the invention provides a portable electronic device in the form of an Android Smartphone. It would be understood though that the invention can be implemented on any suitable device such as an Apple Iphone™, Apple Ipad™, Blackberry™ device, Samsung™ device, Android™ device and any other suitable smart phone, tablet, personal computer or smart electronic device.

By way of no limiting definition, the term icon as used herein means a desktop/home screen shortcut which may be an image, text title of default device screen that links to a landing page web URL or application.

A device according to the preferred embodiment is a portable electronic device in the form of a smart phone having a memory for storing applications and information relating to a plurality of icons. The portable electronic device includes a display for displaying at least one of icons and a user interface for allowing the user to select the at least one icon displayed on the display. The device further has a processor for determining which of the plurality of icons to be displayed on the display according to a predetermined criterion and in what prescribed manner. Each of the icons stored on the memory links to a secondary application or URL and the secondary application or URL is actuated upon selection of the respective displayed icon by the user. In this embodiment each secondary application or URL includes advertisements which are targeted towards the user of the device.

As would be understood the smart phone has a network interface for connecting the device to a mobile telephone network. The telephone network includes data connection and is in network communication with the Internet. In some instances the mobile phone may have a WIFI connection and can connect to the Internet through WIFI. According to the device, other embodiments may include Bluetooth or Ethernet connections.

Also connected to the Internet is an information server that stores information to update the application running on the smart phone. The information server stores data about the usage of the smart phone and information relating to the plurality of icons. The information server is in communication with the smartphone and the server updates the application at regular intervals according to the preferences of a system administrator.

The determination of which of the plurality of icons is displayed on the device includes at least one of following criteria: time (including time of day, month or year); user information (such as user age, sex, interests); historical user selection of the icon; other icons present on the device; statistics based on the device or application usage.

The determination of prescribed manner in which icons are displayed on the device includes at least one of following criteria: time (including time of day, month or year); user information (such as user age, sex, interests); historical user selection of the icon; other icons present on the device; statistics based on the device or application usage.

Once the application is installed the application determines, using the criterion set by the system administrator, which icons to display on the smart phone display and to which applications or URL those icons link. The application will dynamically change the icons displayed to the user and the associated links as required. For example, the icon/s displayed on the phone may change every hour, may change from day to night, may change according to the user usage, characteristics, preferences and the like. In this way the user can be specifically targeted with advertisements according to their preferences and according to the expected engagement level. That is, the user is more likely to be targeted with advertisements that they are interested in and that they are more likely to act on.

As described above, the smart phone display will dynamically change the icons associated with the application throughout the day/night and according to the criterion so as to increase the engagement of the user.

Depending on the particular electronic device being used, the application would be installed as per the normal process for the particular device and the icons are installed on the desktop, menu or start bar as appropriate.

The icon/s can be changed (or optimized) depending on a number of variables (including time of day, number of times an app is opened, played, rewards or special offers of the game, number of levels completed and so on). Other optimization parameters could include elapsed time, offer expiry, icon type.

In the preferred embodiment, the information server tests particular icons to assess how many more times it is opened. The testing can be by way of recording detailed statistics on a particular icon installed on a number of devices and comparing that with other icons with similar characteristics of usage, applications, devices and users. In this way the information server can provide more tailored icons to each device in order to increase engagement

Also in the preferred embodiment the icon/s can be personalised by the user so as to optimise the user experience and increase engagement.

In the preferred embodiment, an application utilizes advertising software to install icons onto the device. These icons are installed on the home or icon screen. In some embodiments, the developer of the application utilises advertising software to install icons and can customizing or optimize the icon displayed. As would be understood the advertising client may select to optimize and provide, for example, different icons to the information server to place. It should be appreciated that the advertising client will provide standard ad serving criteria (e.g. location targeting, device targeting and so on) and that these will be applied in addition to the optimisation rules handled by the information server.

In some embodiments the information server acts to deliver, install or display applications when a user opens an icon.

In another preferred embodiment the information server acts to deliver advertisements to the user when a user opens an icon. In this embodiment an application is again installed on the device or an advertising offer is accepted from within a web browser.

In another preferred embodiment the icons installed to the device are used directly for advertising purposes. The advertising icons are changed according to the variables and criteria as described above.

In these advertising embodiments the application is in communication via the Internet to the information server in the forms of an advertisement platform which stores information on advertisements.

As would be understood, the application may install multiple icons on the device each icon being dynamic in its own way and in some embodiments collectively. In these embodiments, each icon may be designated as a different type of icon having varying optimizations schemes applied thereto.

In the preferred embodiment, user notification messages including inducements may be displayed before, during or after icon optimization.

In the preferred embodiment, the user may opt out of the optimization process. In addition the user has the ability to remove icons as desired. As would be understood though in some embodiments the user does not have the ability to opt out or delete the icons without removing the entire application.

FIG. 1 shows a smart phone in the form of Iphone 101. The phone includes screen 102 on which application 103 is installed. Application 103 installs dynamic icons 104, 105 and 106 on the phone. Icon 104 links to an advertisement whereas icons 105 and 106 are links to sponsored games. Each of the icons is dynamic meaning that the graphical representation of the icons and the advertisements and/or games they link to change according to predetermined criterion.

FIG. 2 shows the preferred system 201 according to the invention. Iphone 202 is connected to mobile telephone network 204 through to the Internet cloud 203. Iphone 202 includes an app 205 stored in its memory and includes information relating to the icons 206. The app 205 is in communication with an information server 207 which that is also connected to the Internet 203. The information server includes details of all the applications 208a and advertisements 208b which can be provide to all users of the system including the user of Iphone 202 Server 207 is managed by an administrator 209 who maintains and updated the applications and advertisements through web browser 210. In some embodiments the server 207 can be duplicated for redundancy or a separate server can be used for different geographical locations. This is illustrated by redundant server 211. Vendors 212 wishing to use the system to provide advertisements or applications to users of the system can do so by browsing to management website 214 on browser 213. The management website allows the vendors to provide details of the applications and advertisements and to attend to any payment required to the provider of the system. Advertisements and applications may need to be reviewed by the administrator 209 prior to being uploaded the information server 207 but this can be tailored according to the particular business rules desired.

As would be understood, system 201 is provided as an example only and modification can be made thereto without going outside of the scope of the invention.

In use, the user of Iphone 202 downloads an application (App) from the Apple App Store. The software install in the memory of the Iphone 202. The App includes information on the icons which are activated when the user actuates the application downloaded. As part of the installation process an icon or icons are installed on the desktop of the phone.

Once actuated, the application is in communication with the information server and provides usage information to the information server and receives optimisation information, applications, advertisements and updates from the information server.

Any commercial processor may be used to implement the embodiments of the invention either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD, Intel Centrino™, Intel Core Duo™, Intel Core 2 Duo™, Intel Centrino™, Intel Xeon™ and the like.

Display screens may be segment display screen, analogue display screens, digital display screens, CRTs, LED screens, Plasma screens, liquid crystal diode screens, and the like.

Although the invention has been described with reference to specific examples, it will be appreciated by those skilled in the art that the invention may be embodied in many other forms.

What is claimed is:

1. A portable electronic device comprising:
a memory for storing a plurality of applications and information relating to a plurality of icons;
a display for displaying at least one of the icons;
a user interface for allowing the user to select the at least one icon displayed on the display; and
a processor for determining which of the plurality of icons to be displayed on the display according to a predetermined criterion

2. A portable electronic device according to claim 1 wherein the processor further determines the prescribed manner in which the icons are displayed.

3. A portable electronic device according to claim 2 wherein at least one of the respective icons actuates a respective secondary application when selected by the user.

4. A portable electronic device according to claim 3 wherein the secondary applications include app marketplace applications and/or web browsers.

5. A portable electronic device according to claim 4 wherein the secondary applications include advertisements.

6. A portable electronic device according to claim 5 wherein at least one of the respective icons actuates a uniform resource locator (URL).

7. A portable electronic device according to claim 6 wherein the URL links include advertisements.

8. A portable electronic device according to claim 7 wherein the electronic device includes a network interface for connecting the device to a network being the Internet.

9. A portable electronic device according to claim 8 wherein the electronic device communicates with an information server via the Internet for updating the information relating to the plurality of icons on the portable electronic device.

10. A portable electronic device according to claim 9 wherein the criterion for determining which of the plurality of icons to be displayed or updated on the display of the device and/or the manner of the icons being displayed on the display includes at least one of: time (including time of day, month or year); user information (such as user age, sex, interests); historical user selection of the icon; other icons present on the device; statistics based on the device or application usage; usage analysis/profile; user profile.
